(19) United States
(12) Patent Application Publication
(10) Pub. No.: US 2024/0292811 A1
(43) Pub. Date: Sep. 5, 2024

(54) SYSTEM FOR DETERMINING A TIME DISTRIBUTION OF AN ANIMAL INTO ZONES OF A BARN

(71) Applicant: DELAVAL HOLDING AB, Tumba (SE)

(72) Inventor: Peter BAHLENBERG, Tumba (SE)

(21) Appl. No.: 18/575,688

(22) PCT Filed: Jun. 23, 2022
(86) PCT No.: PCT/SE2022/050629

§ 371 Date: Dec. 29, 2023

(30) Foreign Application Priority Data
Jul. 1, 2021 (SE) 2130184-1

(51) Int. Cl. A01K 29/00; G01S 7/285; G01S 13/10; G08B 21/18

(52) U.S. Cl. CPC A01K 29/005; G01S 7/285; G01S 13/10; G08B 21/182

(57) ABSTRACT

System for determining distribution of time that a respective animal has spent in different zones of a barn during a predetermined time period. The system includes a Real-Time Location System, a database including position coordinates of the respective zones and a processing controller. The processing controller is configured to determine distribution of time by associating each obtained data entity with a respective zone based on the position coordinates of the respective information entity and the position coordinates of the zones; counting the number of data entities in each respective zone; and calculating an amount of time the animal has spent in the zone by multiplying the number of data entities of each respective zone with the regular time interval.

### Description

The invention relates to a system for determining distribution of time that an animal has spent in different zones of an agricultural indoor environment such as a barn for cows, dur-ing a predetermined time period.

Dairy farms often comprise automatic milking systems, allowing the animals to stroll around freely in a dwelling area and may visit an automatic milking equipment, such as a milking robot, rotating milking parlour, etc., for milking. The animals may then voluntarily go and visit the automatic milking equipment for being milked, tempted by nutrition offered at the automatic milking equipment, and/or sorted out by a gate in a forced animal traffic layout in the barn. This is sometimes also referred to as a voluntary milking system, or just robotic milking.

Herds of animals are becoming bigger and bigger. It may become a challenge for the farmer to detect an exception animal, like animals predicted to be in heat (for performing insemination); as well as sick or injured animals or animals with an otherwise abnormal state or behaviour. Several attempts have been made to find solutions for this purpose, for example based on measurement and analysis of milk yield, rumination, milk composition, hormones, etc., of the respective animal. However, they all have their limitations. It may for this reason be desired to find another methodology to identify the exception animal, to be utilised alone, or in combination with other measurements.

Real-Time Location Systems (RTLS) have emerged to enable location of animals indoors, for example in the barn. The animal is provided with a tag comprising a radio transmitter transmitting radio signals, or blinks. These radio signals of the tag are received by receivers, or anchors as they also may be referred to, which are positioned at different known positions in the barn. The receivers may determine direction, angle of arrival and/or time delay of the received signals and forward this information to a positioning controller, which is calculating a set of position coordinates of the animal based on one or more signal locating algorithms, such as trilateration, multilateration, and/or triangulation of the radio signals of the tag/radio transmitter, as received by the respective receivers.

The current position of the animal may thereby be determined. However, various problems are associated with RTLS. The mere fact of being able to detect the current position of the animals within the barn does not help much in determining current animal status.

It is an object of the present invention to enable a simulation of the farmer's daily animal surveillance and close contact with the herd and enable detection of an exception animal.

This object is achieved by a system according to claim 1. In particular, the system aims at determining distribution of time that a respective animal has spent in different zones of a barn during a predetermined time period. The zones may be dedicated for a respective activity comprising for example a feeding zone dedicated for eating, a resting zone dedicated for resting and/or a transportation zone dedicated for walking. By determining time distribution that the animal has spent in different zones, it is indirectly also determined a distribution of activities performed by the animal.

The system comprises a processing controller and a database. The database is configured to store position coordinates of the respective zones of the barn. The system also comprises a positioning controller and a set of tags, wherein each tag is associated with the respective animal. Each tag comprises a processing device, a radio transmitter and a memory. The memory stores a tag identity i.e., a code which is uniquely identifying the tag. The tag is in turn associated with an animal identity of the animal associated with/carrying the tag, for example in a look-up table or in the database. The processing device is configured to transmit a radio signal via the radio transmitter, repeatedly at a regular time interval; wherein each radio signal comprises the tag identity.

The regular time interval between radio signal transmissions may be for example about every 2.2 seconds. Other regular time intervals such as every 2 seconds, every 3 seconds, etc., may be applied in other embodiments.

The system also comprises at least three receivers, positioned at a respective predetermined position in the barn. The receivers, or anchors, are each one configured to receive the transmitted radio signals and communicate information related to the received radio signals with the positioning controller. The communicated information may comprise for example a measured angle of arrival of the received signal, a measured signal strength of the received signal and/or a time of arrival/delay time of the received signal.

The positioning controller is configured to repeatedly obtain the information related to the received radio signals, received from the respective receivers. The positioning controller then, for each tag identity calculates a set of position coordinates of the tag comprising the respective tag identity based on the information related to the received radio signals of the radio transmitter received by the receivers. The positioning controller is also configured to provide data entities, each data entity comprising the calculated position coordinates of the tag associated with a timestamp and/or an index number to the processing controller.

The processing controller is configured to determine distribution of time that an animal associated with the tag comprising the tag identity has spent in different zones of the barn by associating each obtained data entity with a respective zone based on the position coordinates of the respective information entity and the position coordinates of the zones. Then, the number of data entities in each respective zone are counted and a calculation is made, concerning amount of time the animal has spent in each respective zone by multiplying the number of data entities associated with each respective zone with the regular time interval, such as for example 2.2 seconds.

Thereby, a distribution of time the animal spends in each respective zone, and thereby also indirectly an approximation of the activity performed by the animal during the predetermined time period is determined. As most animals are reliable creatures of habit, a deviation from a normality behaviour could immediately be detected by the farmer. The farmer is at an early stage enabled to detect a deviating animal behaviour, for example by comparing current distribution of time in the different zone, with an expected/average distribution of time. The farmer could at an early stage implement executive decisions concerning appropriate measures, depending on the kind of deviations, such as for example apply insemination when heat is indicated due to excess walking/activity, i.e. when the animal spends more time than average/expected in a transportation zone of the barn. The farmer is also enabled to make visual health inspection for the particular animal when walking activity is low and/or resting time is high and/or eating time is low. Thereby, competent veterinarian assistance could be applied at a very early stage, eliminating, minimising or at least reducing time in a deviating state of the animal, and thereby also suffering of the animal while increasing milk yield of the farm.

In case the animal spends too little time eating at the eating zone of the barn, the reason may be that the animal is low ranked and may never/seldom be able to access the fodder table, which may require change of fodder group for the particular animal, etc.

In some embodiments, the database comprises historical distribution of time that the respective animal has spent in different zones of the barn. The determined distribution of time that the animal has spent in different zones may be compared with historical distribution of time that the animal has spent in these zones, extracted from the database. In case the deviation between the determined distribution of time and the historical distribution of time of the animal exceeds a threshold limit, an alert may be generated based on the made comparison. Also, the determined distribution of time that the animal has spent in the different zones may be stored in the database, thereby forming part of future reference distribution of time of the animal.

Deviations between the current time distribution between different zones/activities and historical time distribution could thereby be detected automatically and the farmer could instantly be alerted for taking appropriate measures.

The historical distribution of time that the respective animal has spent in different zones of the barn may be stored in the database associated with a time of the day when the distribution was determined. The processing controller may then be configured to determine the time of the day when the distribution of time that the animal has spent in different zones is determined using a clock functionality and make the comparison with historical distribution of time the animal at the corresponding time of the day.

The animals will behave differently at different times of the day, and for example be resting more at night-time while being more active at daytime. By storing and comparing time distribution made at the same time of the day, it is assured that a relevant comparison is made. Another advantage by determining the time of the day when determining the animal position/activity is that a change in behaviour over time of an animal could be detected, which may relate to animal status and condition, which may impact milk yield.

The processing controller may also define a cluster of obtained data entities having position coordinates within a distance limit and a timestamp and/or index number within a time limit. Position coordinates of a gravity point of the defined cluster may then be calculated. Also, the zone the position coordinates of the gravity point is associated with is determined. In addition, the processing controller may determine that all data entities of the cluster are associated with the zone of the cluster gravity point.

The positioning of an animal/tag standing close to a border between two zones may swap between the zones although the animal in reality may move only within the same zone, or not be moving at all. The reason is for example signal interference, reflections of radio signals against different objects in the barn, for example. By defining clusters and categorise all data entities of the cluster into the zone of the coordinates of the gravity point, a more reliable zone categorisation may be made.

The processing controller may additionally be configured to determine zone association of the respective data entity by applying a rolling average of the position coordinates of the preceding data entities within a predetermined window length and associating all data enti5 ties within the predetermined window length with the same zone.

Hereby another, or additional solution providing enhanced zone determination of the tag/animal is achieved, which may be important in particular when the animal is situated close to a zone border.

The tag may alternatively also comprise an accelerometer. The accelerometer may determine movement data of the animal, or rather the body part wherein the tag/accelerometer is attached. Each data entity may thereby comprise accelerometer data of the accelerometer. The processing controller may also be configured to detect that the animal is ruminat15 ing at position coordinates of any one of the obtained data entities, based on analysis of the accelerometer data of the data entity. In case the position coordinates of the data entity are situated close to a limitation/border of the resting zone associating the data entity of the animal with the resting zone when rumination is detected.

A typical behaviour of at least some animals such as cows, is that they are ruminating fodder several times, typically while they are resting in a resting cubicle. Thus, when an animal is situated close to the border between the resting zone and any other zone, the animal may be considered located in the resting zone, as concluded based on accelerometer detections of the rumination of the animal.

In some embodiments, the processing controller may be configured to compare the calculated time the animal has spent in the transportation zone with a heat time threshold limit and generate a heat alert for the animal when the heat time threshold limit is exceeded. The heat time threshold limit may be individually adapted to the particular animal, or alter30 natively comprise a general/average value.

The farmer is thereby enabled to detect heat of the animal at an early stage, which is important for successful insemination, which in turn is important for the milk yield at the farm.

The processing controller may also, or alternatively be configured to compare the time the animal has spent in the resting zone with a passivity time threshold limit, and generate an anomaly alert for the animal when the passivity time threshold limit is exceeded. The passivity time threshold limit may be individually adapted to the particular animal, or alternatively comprise a general value.

The farmer is thereby enabled to detect an animal which is sick or hurt at an early stage and is thereby also enabled to apply appropriate solutions (medications, veterinary visit, etc.), thereby shortening and/or eliminating down time of the animal, which enhances milk production.

The radio transmitter of the tags may be configured to transmit a radio signal in an Ultra-Wide Band (UWB), which is an appropriate radio technology for indoor positioning.

At least one of the zones of the barn may in alternatives be divided into sub-zones. The sub-zones of a resting zone may be a number of cubicles, the sub-zones of a feeding zone may comprise feeding stations, for example. The processing controller may be configured to compile the calculated amount of time each animal has spent in each sub-zone. Also, the processing controller may detect a sub-zone which is used less than a threshold time, based on the compilation.

By dividing one or several zones into sub-zones, and determining the animal positioning at a sub-zone level, it could be determined for example whether the animal dislike certain sections of the barn; and/or whether there are sections of the barn that all animals avoid. The farmer may then be recommended to inspect the section in question to figure out why the section is avoided. It may be a cubicle which is perceived as uncomfortable by the animals for example. The farmer may then implement different solutions (better bedding on the floor, improved ventilation, . . . ) and follow up the animal utilisation of the zones/subzones of the barn, an optimal utilisation of the barn area may be obtained. It may even be possible to add more animals to the farm, thereby increasing milk yield of the farm.

The system may in addition also comprise an output device, such as a computer, portable communication device, a computer tablet, etc., of the farmer. The processing controller may be configured to output information concerning distribution of time that the animal has spent in different zones of the barn on the output device. In yet some embodiments, the processing controller may be configured to output the generated alert on the output device.

The farmer is consequently provided with information and alerts for continuous monitoring of the herd and is enabled to detect behaviour deviations of an animal at an early stage.

### FIGURES

The invention will subsequently be explained further with reference to non-limiting embodiments, as schematically shown and described in the appended drawings, in which:

FIG. 1 illustrates an example of a barn interior comprising a system, according to an embodiment of the invention;

FIG. 2 illustrates an overview image of a barn according to an embodiment;

FIG. 3 illustrates a virtual map of the barn according to an embodiment;

FIG. 4A-F illustrates a track sequence of information entities in a virtual map of the barn according to different embodiments;

FIG. 5 illustrates a tag comprising various entities in an embodiment.

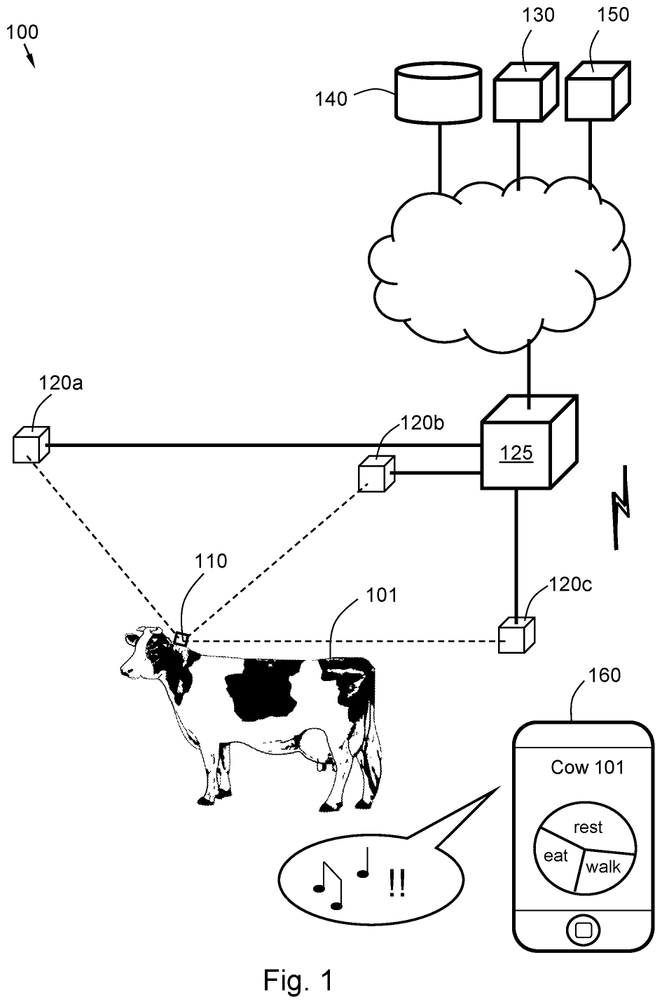

FIG. 1 is an illustration depicting an example of a barn interior comprising a system 100, according to an embodiment of the invention. An animal 101 is associated with a tag 110, comprising a radio transmitter which repeatedly, for example at a regular time interval is transmitting a radio signal, or blink; for example, about every 2.2 seconds in some examples. The regular time interval may be set to another time interval, for example parts of a second, every second, every 3 seconds, etc.

The animal 101 may be a cow as illustrated in FIG. 1, but may in other examples be any arbitrary domesticated animal, such as for example bull, horse, goat, sheep, camel, dairy buffalo, yak, etc.

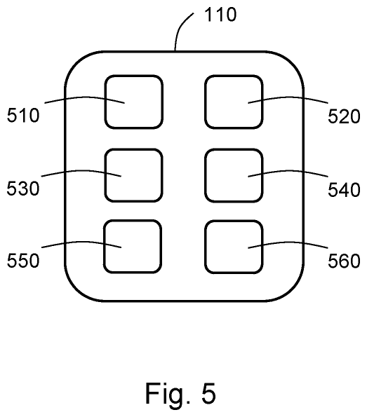

The tag 110 is attached to a body part of the animal 101, such as around the neck or pierced in one of the ears of the animal 101, or possibly any other body part. The tag 110 may have a memory which may comprise data which is uniquely identifying the tag and/or the animal 101, i.e. an identity reference such as a locally or globally unique number, name, and/or code, etc. Details of the tag 110 and various components comprised therein are illustrated in FIG. 5 and discussed in the corresponding section of the description.

The transmitter of the tag 110 emits wireless signals which may be received by a positioning controller 130 via a number of receivers 120a, 120b, 120c, such as typically at least three receivers 120a, 120b, 120c. These receivers 120a, 120b, 120c, or anchors, are mounted in the barn at predetermined, known positions, which are distinct from each other.

The wireless signals may be transmitted between the transmitter of the tag 110 and the wireless signal receivers 120a, 120b, 120c via any convenient wireless communication technology such as Ultra-Wide Band (UWB), Bluetooth (BT), Wireless Universal Serial Bus (Wireless USB), Radio-Frequency Identification (RFID), Wi-Fi, etc.; hereby the location of the tag 110, and thereby indirectly of the animal 101 associated with the tag 110 may be determined.

Wireless signalling based on UWB may provide certain advantages and a more detailed positioning of the tag 110/animal 101 may be made, in comparison with alternative radio band solutions.

Upon repeatedly receiving the data related to the received radio signals, received from the respective receivers 120a, 120b, 120c, possibly via a gateway 125, the positioning controller 130 is configured to, based on the tag identity, calculate a set of position coordinates of the tag 110 comprising the tag identity based on the information related to the received radio signals of the radio transmitter 110 received by the receivers 120a, 120b, 120c.

The positioning controller 130 may determine position of the tag 110, based on signals emitted by the tag 110. The position of the tag 110 (and thereby also of the associated animal 101) may be made e.g. via triangulation or trilateration in at least two directions, e.g. two perpendicular directions such as X and Y. In some embodiments, the position of the tag 110 may also be determined in Z direction.

Each data entity composed by the positioning controller 130 may comprise, or at least be configured to comprise, a timestamp, a tag identity, a blink index number, an X coordinate, an Y coordinate, a Z coordinate, and/or accelerometer data.

In an ideal situation, the receivers 120a, 120b, 120c may receive every blink of the tag 110, thereby enabling the positioning controller 130 to continuously determine the position of the tag 110. However, a blink may not be received by one, some or all of the receivers 120a, 120b, 120c, thereby producing a gap in the series of blinks.

Sometimes, the received blink may be distorted or disturbed by interference with other signals or signal reflections by obstacles in the barn, which affect positioning of the tag 110/animal 101.

The positioning controller 130 is configured to provide data entities, each data entity comprising the calculated position coordinates of the tag 110 comprising the tag identity, associated with a timestamp and/or an index number to a processing controller 150 and/or a database 140.

The computational functions of the provided system 100 has in the illustrated example been divided between one positioning controller 130 and one processing controller 150, which are physically separated both from each other and from the farm. In other embodiments however, the computational functions of both the positioning controller 130 and the processing controller 150 may be performed by one single controller, which may be situated at the farm, or remotely therefrom while communicationally connected. In yet other embodiments, the described computing functions of the positioning controller 130 and the processing controller 150 may be sub divided into additional controllers, which may be communicationally connected with each other, thereby enabled to perform the computations of the system 100.

The processing controller 150 and/or the database 140 may be remotely situated in relation to the farm, connected to the positioning controller 130/RTLS via a wired or wireless network in some embodiments. Thereby, data processing, calculations and data storage may be made centrally, which saves resources and spare the farmer from data maintenance, software updates, etc.

Alternatively, the processing controller 150 and/or the database 140 may be locally situated at the farm. Thereby a solution is achieved, which is independent in relation to network connection functionality.

The collected data may thereby be obtained and analysed by the processing controller 150, for example by sorting the obtained data entities in order of sampling based on index number and/or timestamp during a predetermined time period, associated with the same animal 101. A lost data entity, or data entity comprising no, or incomplete data may thereby be detected.

Data entities not comprising position coordinates (X/Y and possibly Z), or at least not complete position coordinates may be eliminated.

In an example, analysis of the obtained data entities may result in filtering and removal of outlier positions.

In case there is a gap of one or some few data entities, an interpolation may be made based on the preceding and the subsequent data entities; or possibly an extrapolation based on the preceding data entities.

The processing controller 150 may then determine distribution of time that the animal 101 has spent in different zones of the barn.

The system 100 may comprise an output device 160, for example a portable/stationary display of the farmer. Information concerning distribution of time that the animal 101 has spent in different zones of the barn, and/or various alerts may be output, catching the farmers attention to the most anxious animal behaviour detected.

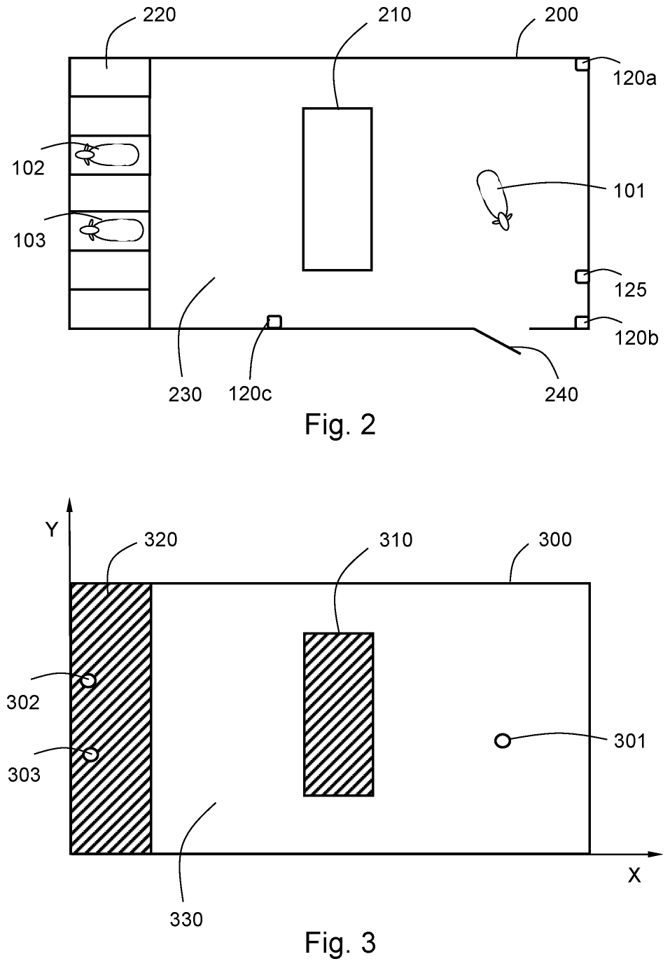

FIG. 2 illustrates an overview of a barn 200 in a possible embodiment, wherein the signal receivers 120a, 120b, 120c may be situated, for receiving radio signals transmitted by the tag 110 of the respective animals 101, 102, 103.

The barn 200 may comprise various zones dedicated for different purposes, such as for example a feed table 210 for eating, cubicles 220 for resting, and a walking zone 230 for transportation and strolling around and socialising. In this case, the barn also has a door 240, where the animals 101, 102, 103 may exit the barn 200, for example to a meadow field, for outdoor recreation. It may be estimated how long time the animal 101, 102, 103 spend outside by assuming the animal 101, 102, 103 exits the barn 200 when no more radio signalling is received from his/her tag 110, after having been located close to the door 240, and correspondingly assuming returning to the barn 200 when reappearing at the door 240.

In other barns 200, there may be a water dispenser zone, a brush zone, a milking robot zone, a waiting zone for accessing the milking robot, a milking zone, multiple entrances/exit zones, etc.

FIG. 3 illustrates a virtual representation 300 of the barn 200 comprising sets of position coordinates 310, 320, 330, corresponding to the position coordinates of the respective zones 210, 220, 230 of the barn 200.

The current position of the respective animal 101, 102, 103 may be represented by a respective data entity 301, 302, 303 comprising an X and a Y coordinate each, besides other data as already mentioned.

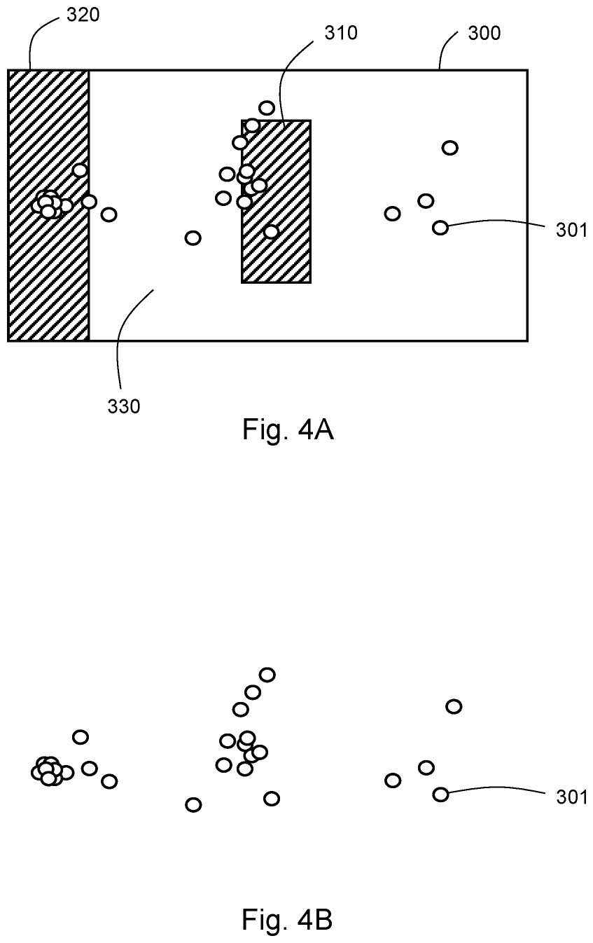

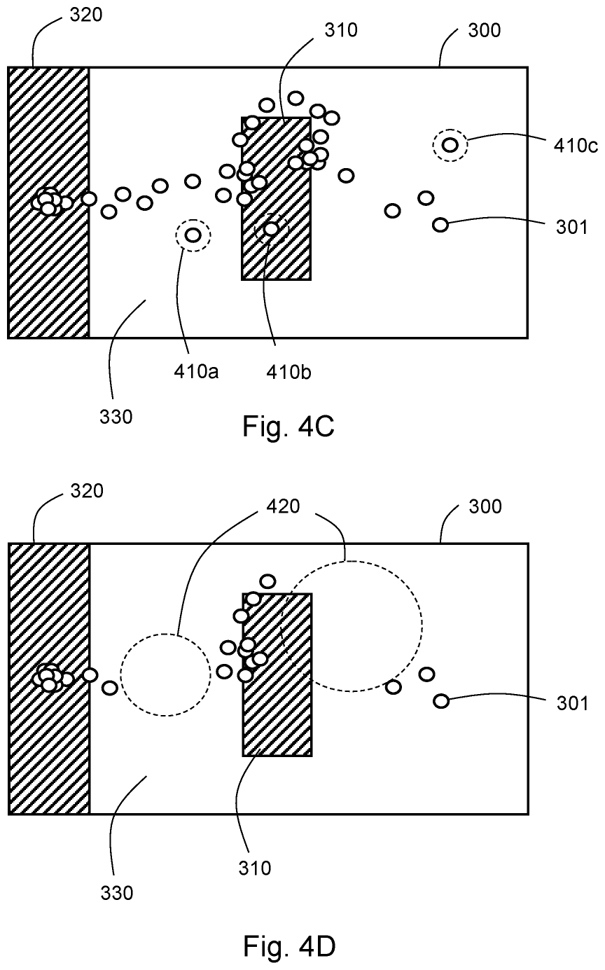

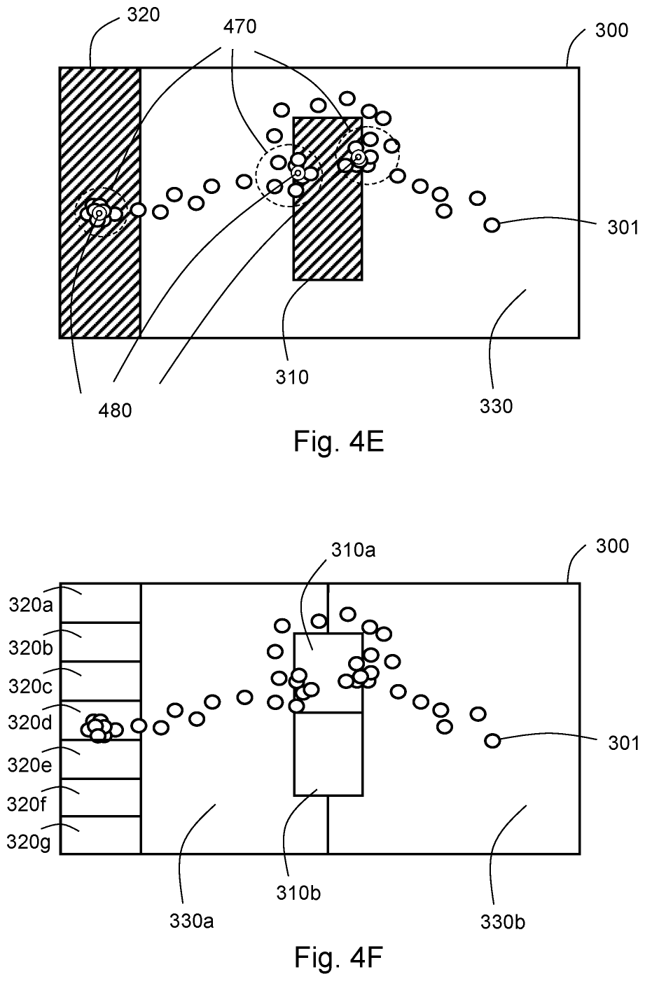

FIG. 4A schematically illustrates data entities 301 of one particular animal 101, which have been captured during a predetermined time period, for example about 10-20 minutes, some hours, or some other user defined time period.

It is desired to determine the distribution of time that the animal 101 has spent in different zones 210, 220, 230 of the barn 200 during the predetermined time period.

FIG. 4B schematically illustrates data entities 301 of one particular animal 101 during the predetermined time period. By sorting the data entities 301 in order of sampling, based on index number, and/or timestamp, a lost data entity 301 may be detected and replaced by interpolation/extrapolation of the surrounding/preceding data entities.

FIG. 4C schematically illustrates an example of data entities 301, wherein outlier data entities 410a, 410b, 410c are filtered out and deleted according to some different principles or methodologies.

Due to reflections of radio waves, signal interference between tags 110 of different but closely positioned animals 101, 102, 103, etc., some data entities 301 may comprise position coordinates which are incorrect in relation to the actual position of the animal 101. The signalling may also be at least temporarily affected by various machines etc., temporarily placed or moving around in the barn.

Thus, signals may be lost, and/or alternatively comprise incomplete information for enabling positioning of the animal 101, 102, 103 at the moment of the transmitted signal. In case only one single signal or possibly some few signals are lost and/or comprises incomplete data, the data entity 301 may be positioned by inserting an interpolated/extrapolated value.

The identification and removal of the most obvious outliers 410a, 410b, 410c due to reflections etc., may be an iterative process, based on velocity calculations of animal velocity between successive data entities 301.

An algorithm for calculating the animal velocity may comprise firstly calculating dx, dy and dt for all data entities 301 and then calculate: v=sqrt (dx²+dy²)/dt.

Thereafter, the position having the highest velocity may be deleted, and the velocities for the remaining data entities 301 in the array 400 may be recalculated, as long as the maximum velocity>2000 mm/s (2 m/s or 7.2 km/h), when the animal 101 is a cow. Other animals may have other velocity threshold limits.

Based on velocity distributions from these computations, it may be assumed to be very unlikely that a cow moves faster than 2 m/s, why data entities 301 involving a faster velocity than 2 m/s may be deleted. Sometimes also the data entity 301 before the one having a large velocity may be removed.

It may be assumed that the animal 101 was close to the positions of the data entities 301 before and after a lost or incomplete data entity.

For a sequence of lost or incomplete data entities 301, as illustrated in FIG. 4D, the whereabouts of the animal 101 becomes somewhat more uncertain, and the animal position and distribution of time in different zones 210, 220, 230 may be reconstructed.

FIG. 4E illustrates an example of determining position of the animal 101 and determining distribution of time that the animal 101 has spent in different zones 210, 220, 230 of the barn 200.

The processing controller 150 may in some embodiments define and compose clusters 470 of data entities 301 obtained from the positioning controller 130, having position coordinates within a distance limit and a timestamp and/or index number within a time limit.

Then, a gravity point 480 of the defined cluster 470 may be determined and position coordinates of the gravity point 480 may be calculated. Furthermore, it may be determined which zone 210, 220, 230 the position coordinates of the gravity point 480 is associated with. In addition, the processing controller 150 may determine that all data entities 301 of the cluster 470 are associated with the zone 210, 220, 230 of the cluster gravity point 480.

Hereby fluctuation of position coordinates of the animal 101 is evened out, which is in particular an advantage when the animal 101 is situated close to a border between two distinct zones 210, 220, 230.

FIG. 4F illustrates an embodiment wherein the zones 210, 220, 230, or at least one of the zones 210, 220, 230 may be divided into sub-zones 310a, 310b, 320a, 320b, 320c, 320d, 320e, 320f, 320g, 330a, 330b. The sub-zones 310a, 310b, 320a, 320b, 320c, 320d, 320e, 320f, 320g, 330a, 330b may for example comprise cubicles and/or feeding stations. Possibly, the transportation zone 230 may be divided into different sections.

FIG. 5 illustrates a tag 110, as carried or associated with the animal 101. The tag 110 comprises a processing device 510, a radio transmitter 520 and a memory 530. The memory 530 stores a tag identity unique for the tag 110. The processing device 510 is configured to transmit a radio signal, or blinks, via the radio transmitter 520, repeatedly at a regular time interval such as every 2.2 seconds or there about. Each radio signal comprises the tag identity. The transmitted radio signals may be a radio signal in an Ultra-Wide Band, in an example.

The tag 110 may in some optional embodiments also comprise a device 540 for determining activity of the animal 101, such as e.g. one or several 3-Dimensional (3D) accelerometer, a giro, inertia sensor, etc.

The optional 3D accelerometer 540 of the tag 110 may perform high frequency recordings of bi-axial and/or tri-axial acceleration, which allows for discrimination of behavioural patterns like determining whether the animal 101 is ruminating for example.

The memory 530, stores a tag identity and/or identity reference of the animal 101.

The tag 110 may in some embodiments comprise a receiver 550, configured to receive radio signals. Other entities such as for example the positioning controller 130 and/or the processing controller 150 may communicate commands via a respective associated transmitter, for example to trigger the tag 110 to transmit a signal.

The tag 110 may also comprise an energy source 560, such as a battery, providing energy to the other enumerated entities comprised in the tag 110.

1. A system (100) for determining a distribution of time that a any one of a plurality of animals (101, 102, 103) has spent in different zones (210, 220, 230) of a barn (200) during a predetermined time period, wherein the system (100) comprises:
a processing controller (150);
a database (140), comprising position coordinates of each of the zones (210, 220, 230);
a positioning controller (130);
a set of tags (110) associated with respective said animals (101, 102, 103), wherein each of the tags (110) comprises a processing device (510), a radio transmitter (520) and a memory (530) storing a tag identity, wherein the processing device (510) is configured to transmit a radio signal via the radio transmitter (520), repeatedly at a regular time interval; wherein each radio signal comprises the tag identity of the tag in which the radio transmitter is disposed, and
at least three receivers (120a, 120b, 120c), positioned at aat respective predetermined positions in the barn (200), each of the receivers configured to:
receive the transmitted radio signal; and
communicate information related to the received radio signal with to the positioning controller (130);
wherein the positioning controller (130) is configured to repeatedly:
receive the information related to the received radio signals, received from the respective receivers (120a, 120b, 120c), for each said tag identity;
calculate a set of position coordinates of the tag (110) comprising the respective tag identity based on the information related to the received radio signals of the radio transmitter (520) received by the receivers (120a, 120b, 120c);
provide data entities (301), each of the data entities (301) comprising the calculated position coordinates of the tag (110) associated with a timestamp and/or an index number to the processing controller (150); and
wherein the processing controller (150) is configured to:
determine the distribution of time that the animal (101) associated with the tag (110) comprising the tag identity has spent in different said zones (210, 220, 230) of the barn (200) by
associating each of the obtained data entities (301) with a respective one of the zones (210, 220, 230) based on the position coordinates of the respective data entity (301) and the position coordinates of the zones (210, 220, 230);
counting a number of the data entities (301) in each of the zones (210, 220, 230); and
calculating an amount of time the animal (101) has spent in each of the zones (210, 220, 230) by multiplying the number of the data entities (301) associated with each of the zones (210, 220, 230) with the regular time interval.

2. The system (100) according to claim 1, wherein the database (140) comprises a historical distribution of time that each of the animals (101, 102, 103) has spent in different said zones (210, 220, 230) of the barn (200); and wherein the processing controller (150) is configured to:
compare the determined distribution of time that the animal (101) has spent in different said zones (210, 220, 230) with the historical distribution of time that the respective animal (101, 102, 103) has spent in different said zones (210, 220, 230), extracted from the database (140);
store the determined distribution of time that the animal (101) has spent in different said zones (210, 220, 230) in the database (140); and
generate an alert when a deviation between the determined distribution of time and the historical distribution of time of the animal (101), based on the made comparison, exceeds a threshold limit.

3. The system (100) according to claim 2, wherein the historical distribution of time that the respective animal (101, 102, 103) has spent in different said zones (210, 220, 230) of the barn (200) is stored associated with a time of the day when the distribution was determined; and wherein the processing controller (150) is configured to determine the time of the day when the distribution of time that the animal (101) has spent in different said zones (210, 220, 230) is determined; and make the comparison with historical distribution of time the animal (101, 102, 103) has spent in different zones (210, 220, 230) at the corresponding time of the day.

4. The system (100) according to claim 1, wherein the processing controller (150) is configured to:
define a cluster (470) of obtained data entities (301) having position coordinates within a distance limit and a timestamp and/or index number within a time limit;
calculate position coordinates of a gravity point (480) of the defined cluster (470);
determine an associated said zone of (210, 220, 230) the position coordinates of the cluster gravity point (480); and
determine that all of the data entities (301) of the cluster (470) are associated with the associated zone (210, 220, 230) of the cluster gravity point (480).

5. The system (100) according to claim 1, wherein the processing controller (150) is configured to determine the associated zone of the respective data entity (301) by applying a rolling average of the position coordinates of the preceding data entities (301) within a predetermined window length and associating all of the data entities (301) within the predetermined window length with the same said zone (210, 220, 230).

6. The system (100) according claim 1, wherein the zones (210, 220, 230) comprises a feeding zone (210) dedicated for eating, a resting zone (220) dedicated for resting and a transportation zone (230) dedicated for walking.

7. The system (100) according to claims 6, wherein each said tag (110) comprises an accelerometer (540); and wherein each said_data entity (301) comprises accelerometer data of the accelerometer (540); and wherein
the processing controller (150) is configured to detect that the animal (100) is ruminating at the position coordinates of any one of the obtained data entities (301), based on analysis of the accelerometer data of the data entity (301); and
in case the position coordinates of the data entity (301) are situated close to a limitation of the resting zone (220):
associating the data entity (301) of the animal (101) with the resting zone (220) when rumination is detected.

8. The system (100) according to claim 6, wherein the processing controller (150) is configured to:
compare a calculated time the animal (101) has spent in the transportation zone (230) with a heat time threshold limit; and
generate a heat alert for the animal (101) when the heat time threshold limit is exceeded.

9. The system (100) according to claim 6, wherein the processing controller (150) is configured to:
compare a time the animal (101) has spent in the resting zone (220) with a passivity time threshold limit; and
generate an anomaly alert for the animal (101) when the passivity time threshold limit is exceeded.

10. The system (100) according to claim 1, wherein the radio transmitter (520) is configured to transmit the radio signal in an Ultra-Wide Band.

11. The system (100) according to claim 1, wherein at least one of the zones (210, 220, 230) is divided into sub-zones (310a, 310b, 320a, 320b, 320c, 320d, 320e, 320f, 320g, 330a, 330b), wherein the processing controller (150) is configured to:
compile a calculated amount of time each said animal (101, 102, 103) has spent in each of the sub-zones (310a, 310b, 320a, 320b, 320c, 320d, 320e, 320f, 320g, 330a, 330b); and
detect a sub zoneany of the sub-zones (310a, 310b, 320a, 320b, 320c, 320d, 320e, 320f, 320g, 330a, 330b) which is used less than a threshold time, based on the compilation.

12. The system (100) according to claim 11, wherein the sub-zones (310a, 310b, 320a, 320b, 320c, 320d, 320e, 320f, 320g, 330a, 330b) comprises cubicles and/or feeding stations.

13. The system (100) according to claim 2, further_comprising an output device (160); and wherein the processing controller (150) is configured to:
output, on the output device, information concerning a distribution of time that the animal (101) has spent in different said zones (210, 220, 230) of the barn (200).

14. The system (100) according to claim 13, wherein the processing controller (150) is configured to:
output the generated alert on the output device (160).
